(19) United States
(12) Patent Application Publication
(10) Pub. No.: US 2014/0022969 A1
(43) Pub. Date: Jan. 23, 2014

(54) APPLICATION AND METHOD OF INTER-FRAME GAP REDUCTION IN LOW-POWER TIME-SYNCHRONIZED NETWORKS

(71) Applicants: Igor Ryshakov, Mountain View, CA (US); Paul Berenberg, Mountain View, CA (US); Georgi Danielyan, Yerevan (AM); Armen Hunanyan, Yerevan (AM)

(72) Inventors: Igor Ryshakov, Mountain View, CA (US); Paul Berenberg, Mountain View, CA (US); Georgi Danielyan, Yerevan (AM); Armen Hunanyan, Yerevan (AM)

(73) Assignee: Cubic Corporation, San Diego, CA (US)

(21) Appl. No.: 13/551,477

(22) Filed: Jul. 17, 2012

(51) Int. Cl. H04W 52/02

(52) U.S. Cl. 370/311

(57) ABSTRACT

Techniques are disclosed for reducing the amount of overhead transmitted in ad-hoc low-power wireless networks. Embodiments generally include aggregating a plurality of data packets and prepending and appending each with associated data. The plurality of data packets then can be inserted into a single data frame, or packet for transmission. Gaps may be inserted between the data packets for timing synchronization and/or other purposes.

### STATEMENT AS TO RIGHTS TO INVENTIONS MADE UNDER FEDERALLY SPONSORED RESEARCH AND DEVELOPMENT

The U.S. Government may have rights in this invention pursuant to Contract No. 1406-04-06-CT-60916.

### BACKGROUND OF THE INVENTION

Modern networks can comprise a variety of devices, which may be connected in a variety of ways. A network can be, for example, centralized or ad hoc. In the latter case, each networked device, or node, can act as a router to forward data from other nodes, in addition to communicating its own data.

These wireless networks, however, have their limitations. For example, wireless devices powered by batteries may require frequent battery changes due to the high power cost of wireless data transmission. Because of maintenance issues, among other things, ad hoc wireless networks have may not be used in various applications for which the networks might otherwise be suitable.

### BRIEF SUMMARY OF THE INVENTION

Techniques are disclosed for reducing the amount of overhead transmitted in ad-hoc low-power wireless networks. Embodiments generally include aggregating a plurality of data payloads and prepending and appending each with associated data. The plurality of data payloads then can be inserted into a single data frame, or packet, for transmission. Gaps may be inserted between the data payloads for timing synchronization and/or other purposes. Among other things, the reduced amount of overhead resulting from utilizing such techniques can conserve power, increase efficiency, and reduce congestion.

An example network device for communicating with an ad-hoc, low-power wireless network, according to the description, can include a battery, a wireless interface, and a processing unit coupled with the battery and the wireless interface. The processing unit can be configured to cause the network device to aggregate a first plurality of data payloads, create a first data packet comprising the first plurality of data payloads by appending data to each data payload in the first plurality of data payloads, and send the first data packet via the wireless interface.

The example network device can include one or more of the following features. The processing unit can be further configured to cause the network device to create the first data packet by prepending data to each data packet in the first plurality of data packets. The processing unit can be configured to cause the network device to, for first and second data payloads in the first plurality of data payloads, insert a gap between the appended data of the first data payload and the prepended data of the second data payload. The length of time of the gap can be based on user input. The processing unit can be configured to cause the network device to include either or both of a preamble or a start frame delimiter (SFD) in the prepended data for each data payload in the first plurality of data payloads. The processing unit can be configured to cause the network device to include a cyclic redundancy check (CRC) in the appended data for each data payload in the first plurality of data payloads. The processing unit can configured to cause the network device to receive, via the wireless interface, a second data packet comprising a second plurality of data payloads, and each data payload of the second plurality of data payloads can have corresponding prepended data and appended data. The processing unit can be configured to cause the network device to disregard either or both of prepended data corresponding to the entire second data packet, or appended data corresponding to the entire second data packet. At least one sensor can be communicatively coupled with the processing unit.

An example method for communicating data via an ad-hoc, low-power wireless network, according to the description, can include aggregating a plurality of data payloads, creating, using a processing unit, a first data packet comprising the plurality of data payloads by appending data to each data payload in the plurality of data payloads, and sending the first data packet via a wireless interface.

The example method can include one or more of the following features and/or additional steps. Creating the first data packet further can comprise prepending data to each data packet in the plurality of data packets. For first and second data payloads in the plurality of data payloads, inserting a gap between the appended data of the first data payload and the prepended data of the second data payload. A length of time of the gap can be based on user input. Including either or both of a preamble or a start frame delimiter (SFD) in the prepended data for each data payload in the plurality of data payloads. Including a cyclic redundancy check (CRC) in the appended data for each data payload in the plurality of data payloads. At least one data payload of the plurality of data payloads can include beaconing data from a wireless network device, the beaconing data including information for connecting with the ad-hoc, low-power wireless network.

An example non-transitory computer-readable medium having instructions embedded thereon for communicating data via an ad-hoc, low-power wireless network, according to the description, can have instructions including computer-executable code for aggregating a plurality of data payloads, creating a first data packet comprising the plurality of data payloads by appending data to each data payload in the plurality of data payloads, and sending the first data packet via a wireless interface.

The example non-transitory computer-readable medium can include one or more of the following features. Computer-executable code for prepending data to each data payload in the plurality of data payloads. Computer-executable code for, for first and second data payloads in the plurality of data payloads, inserting a gap between the appended data of the first data payload and the prepended data of the second data payload. Computer-executable code for determining a length of time of the gap is based on user input. Computer-executable code for including either or both of a preamble or a start frame delimiter (SFD) in the prepended data for each data payload in the plurality of data payloads. Computer-executable code for including a cyclic redundancy check (CRC) in the appended data for each data payload in the plurality of data payloads. At least one data payload of the plurality of data payloads can include beaconing data from a wireless network device, the beaconing data including information for connecting with the ad-hoc, low-power wireless network.

### BRIEF DESCRIPTION OF THE DRAWINGS

FIG. 1A is a block diagram of an embodiment of a wireless network for communicating sensor information.

FIG. 1B is a block diagram of another embodiment of a wireless network for communicating sensor information, in which a gateway device is wirelessly connected with the Internet.

FIG. 2 is a block diagram of an embodiment of a gateway device.

FIG. 3A is a block diagram of an embodiment of a wireless sensor device (WSD).

FIG. 4 is an illustration representing a typical packet-based communication in a low-power wireless network.

FIG. 5 is an example of a data packet resulting from utilizing payload aggregation techniques described herein, according to one embodiment.

FIG. 6 is a flow diagram illustrating a method for payload aggregation and transmission, according to one embodiment.

### DETAILED DESCRIPTION OF THE INVENTION

For the purposes of explanation, the ensuing numerous provides specific details are set forth in order to provide a thorough understanding of various embodiments. It will be apparent, however, to one skilled in the art that various embodiments may be practiced without some of these specific details. For example, circuits, systems, networks, processes, and other components may be shown as components in block diagram form in order not to obscure the embodiments in unnecessary detail. In other instances, known circuits, processes, algorithms, structures, and techniques may be shown without unnecessary detail in order to avoid obscuring the embodiments. In other instances, well-known structures and devices are shown in block diagram form.

Embodiments provided herein are examples only, and is not intended to limit the scope, applicability, or configuration of the disclosure. Rather, the ensuing description of the embodiments will provide those skilled in the art with an enabling description for implementing one or more embodiments. It should be understood that various changes may be made in the function and arrangement of elements without departing from the spirit and scope of the disclosed systems and methods as set forth in the appended claims.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Wireless networks and wireless network devices (including wireless sensor devices (WSDs)) described herein may be configured in a variety of ways, in a variety of contexts. Example configurations include mesh, point-to-point, and/or ad hoc networks, among others. The flexible nature of these networks—enabling network devices, or nodes, to join and leave these networks dynamically—together with WSDs configured to collect and communicate sensor information, enables these networks to provide end-to-end security and management of transportation and/or logistical systems. Although disclosed embodiments focus on wireless technologies, the techniques described herein can be applied to wired communication networks, such as an ad-hoc serial interface.

For example, a wireless network can comprise a plurality of WSDs providing sensor information relating to a plurality of cargo containers located in a depot. The sensor information can include data from a variety of sensors, which can indicate the temperature and/or humidity of a container, whether the container door is or has been opened, whether the container is experiencing or has experienced a shock, the location of the container, whether the container is moving, and more. The wireless network further can include a gateway device that collects the sensor information and provides it to systems outside the wireless network. As WSD-equipped containers enter and leave the depot, the wireless network will adjust accordingly, enabling WSDs of containers entering the depot to join the wireless network while the WSDs of containers leaving the depot are dropped from the wireless network. Furthermore, WSDs can act as routers to relay sensor information from other WSDs that are not in direct communication with the depot's gateway device.

Low-power wireless networks can be advantageous in transportation, logistical, and similar applications where network devices are mobile devices operating on battery power. Although many battery-operated mobile devices utilize wireless technologies, most mobile devices exhaust their batteries in a matter of hours or days. The term “low-power wireless networks” as used herein refers to wireless networks utilizing technologies that enable battery-powered devices to operate for a year or more without exhausting their batteries. This can include technologies associated with the IEEE 802.15.4 and/or ISO/IEC 18000-7 standards, as well as various proprietary technologies, among others.

Embodiments of the present invention are directed toward data payload aggregation and transmission techniques that provide for accelerated packet sequence transmission, power consumption reduction, and/or performance improvement in packet-based communication in low-power wireless networks. These techniques can work for protocols which use the same signal modulation for payload, packet preamble, and start-of-frame delimiter (SFD) symbol. Moreover, these techniques, which are described in detail herein below, can be implemented by logistical management systems comprising networked WSDs.

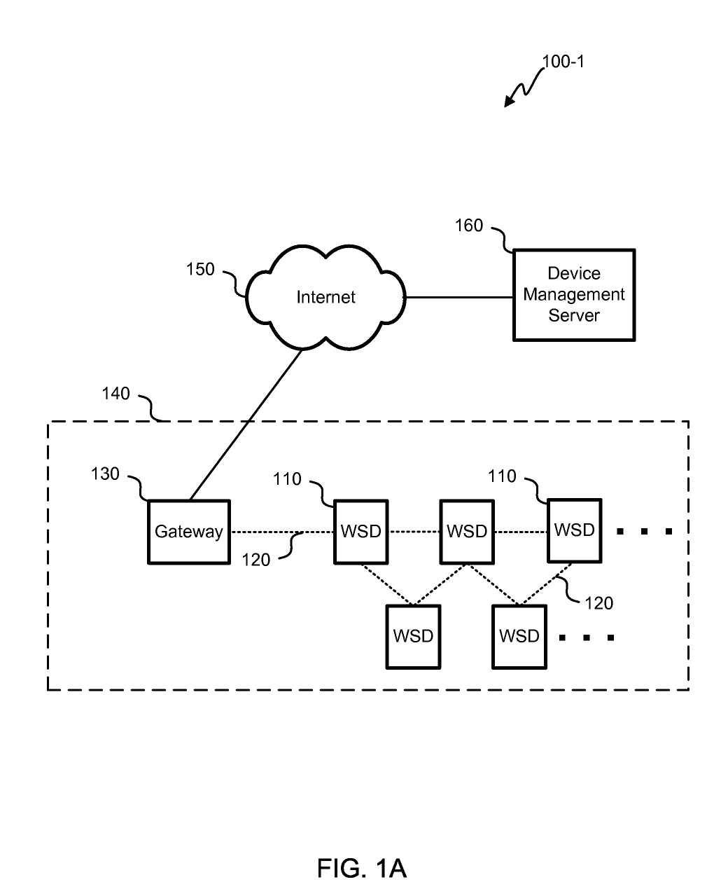

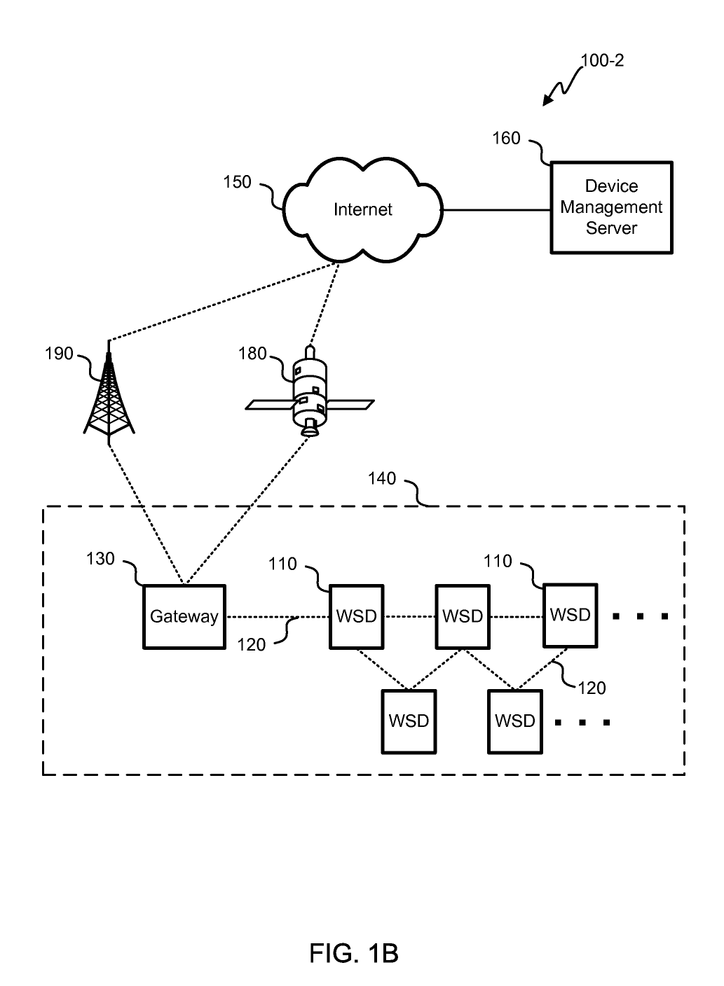

FIG. 1A is a block diagram of an embodiment of a logistical management system 100-1. In this embodiment, a plurality of WSDs 110 are networked together to generate and communicate sensor data. A WSD 110 gathering sensor information can communicate the sensor information toward a gateway 130 using a wireless connection 120. If there are one or more WSDs 110 communicatively linked between the WSD 110 originating the sensor information and the gateway 130, the one or more WSDs 110 will relay the sensor information until it reaches the gateway 130. The logistical management system 100-1 depicted in FIG. 1A is shown as an example and is not limiting. The sensor network 140 can be configured in a variety of ways. For instance, the gateway 130 can connect with multiple WSDs 110, and WSDs 110 can have more or fewer wireless connections 120 than indicated in FIG. 1A. Moreover, multiple gateways 130 and/or sensor networks 140 may be included in a logistical management system 100.

The gateway 130 provides connectivity between sensor network 140—comprising the gateway 130 and WSDs 110—and a device management server (DMS) 160. Communication between the gateway 130 and the DMS 160 can be relayed through the Internet 150, or any other Wide Area Network (WAN). Additionally or alternatively, other networks, such as Local Area Networks (LANs), can be used. Other configurations can include a gateway 130 communicating directly with the DMS 160 without a separate network.

The DMS 160 provides an interface between the sensor network 140 that can be used by a human user or another system, by utilizing, for example, a graphical user interface (GUI) and/or an application programmable interface (API). The DMS 160 can collect and store information from the WSDs 110. The data communicated between the DMS 160 and the gateway 130 can be securely communicated in encrypted packets, and the DMS 160 can provide secure management of the collected data.

One or more of a variety of physical layers may be used to provide the wireless connections 120 of the sensor network 140. According to one embodiment, the WSDs 110 and gateway 130 communicate using a protocol stack based on IEEE 802.15.4 standard at 2.4 GHz using all 16 channels available in that standard. This physical layer enables the sensor network 140 to operate using very low power and/or predictable power consumption—which can be an important consideration for embodiments in which the WSDs 110 and/or gateway 130 operate on battery power. Nonetheless, other wireless technologies may be used, including IEEE 802.15.4 at 900 MHz; IEEE 802.11; Bluetooth®; IEEE 802.16; Ultra Wideband (UWB); 433 MHz Industrial, Scientific, and Medical (ISM) Band; cellular; optical; and more, using multiple RF channels (e.g., narrow-band frequency hopping) or a single RF channel. The gateway 130 can communicate with the Internet 150 through a wired connection and/or a wireless connection, as shown in FIG. 1B.

FIG. 1B is a block diagram of an alternative embodiment of a logistical management system 100-2. In this embodiment, the gateway 130 can communicate with the Internet 150 wirelessly, through wireless communications with a satellite 180 and/or a cellular tower 190. The user of such a wireless interface between the gateway 130 and the internet 150 can be a factor of available internet connectivity and desired mobility of the sensor network 140, among other considerations.

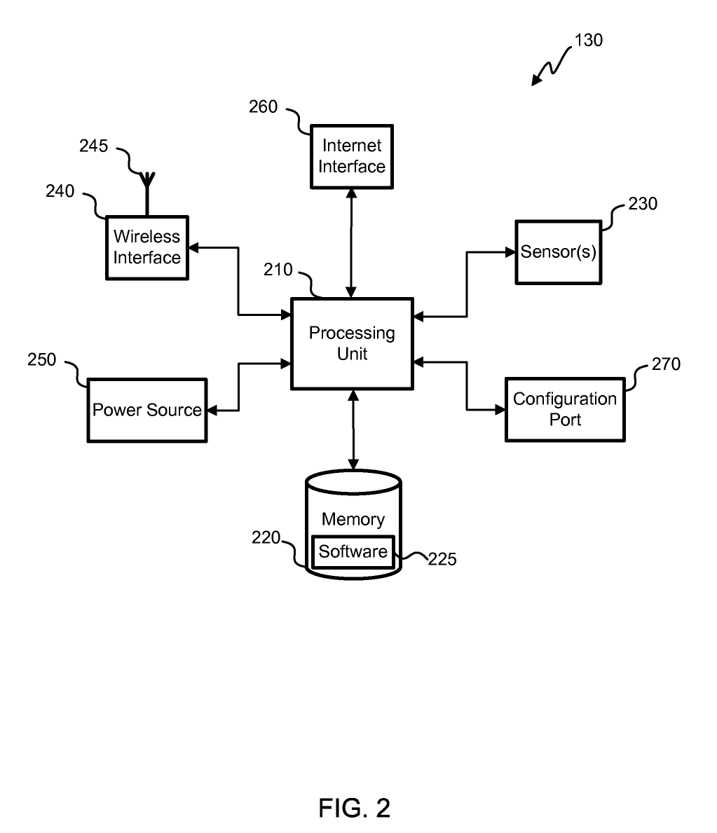

FIG. 2 is a block diagram of an embodiment of a gateway device 130. This block diagram, as with other figures shown herein, is provided as an example only, and is not limiting. The gateway device 130 can be configured in alternate ways by, for example, including a global positioning system (GPS) unit and/or other components not shown in FIG. 2.

A processing unit 210 lies at the heart of the gateway device 130. The processing unit 210 can be comprised of one or more processors, microprocessors, and/or specialized integrated circuits. The processing unit 210 can gather information from the other components of the gateway device 130 and process the information in accordance with software 225 disposed in a memory 220. Depending on desired functionality of the gateway device 130 and the capabilities of the processing unit 210, the software 225 can include an operating system with one or more executable programs. Alternatively, the software can include lower-level instructions, such as firmware and/or microcode, for the processing unit 210 to execute.

The power source 250 supplies power to the components of the gateway device 130 and may provide additional information (e.g., battery charge, voltage levels, etc.) to the processing unit 210. For a mobile gateway device 130, the power source 250 can comprise one or more batteries. For a fixed gateway device 130, the power source can include a power converter, transformer, and/or voltage regulator.

The wireless interface 240 provides communication with WSDs 110. As indicated above, this communication can be effectuated using any of a variety of technologies, including radio frequency (RF) and/or optical communication technologies. Where RF technologies are used, the wireless interface can include an antenna 245.

The gateway device 130 can also include a configuration port 270, which can allow a device, such as a computer, to be connected to the gateway device 130 for the purposes of configuring the gateway device 130. The configuration port 270 can comprise universal serial bus (USB) connector, serial port, optical, or other connector to input information from an external device. Depending on the functionality of the gateway device 130 and/or WSDs 110, the configuration port 270 may be used to configure device information and reporting, sensor parameters, software, security, network parameters, power consumption, GPS parameters, file management, and more.

The Internet interface 260 can be any of a variety of interfaces, depending on desired functionality. As indicated in FIG. 1A, the gateway device 130 can have a wired connection with the Internet, in which case the Internet interface 260 can include an Ethernet or other wired interface. Additionally or alternatively, the gateway device 130 can have a wireless connection with the Internet, as indicated in FIG. 1B. In this case, the Internet interface can comprise one or more wireless radios, such as a dual-mode WAN radio enabling cellular and satellite communication.

The gateway device 130 further can include sensor(s) 230, enabling the gateway device to collect sensor information similar to the WSDs. This sensor information can include information relating to temperature, humidity, motion, light, battery charge, shock, and application-specific information (e.g. the state of a door—open or closed—on a cargo container). Depending on desired functionality, the processing unit 210 may collect, process, and/or record the sensor information, or the processing unit 210 simply may send unprocessed sensor information to the DMS 160 using the Internet interface 260.

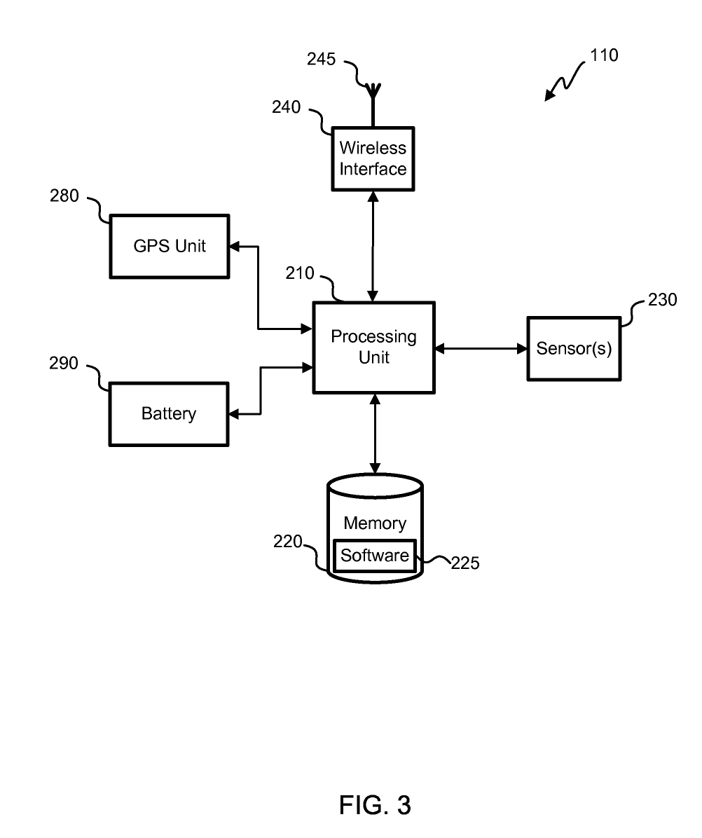

FIG. 3 is a block diagram of an embodiment of a WSD 110. This embodiment includes many components—such as the sensor(s) 230, processing unit 210, memory 220, and wireless interface 240—that are similar to the gateway device 130. Here, however, the components may be simpler than corresponding components of the gateway device 130, due to power and functionality considerations. For example, the processing unit 210 can comprise a microprocessor and the memory 220 and software 225 can comprise programmed logic of the microprocessor. It can also be noted that the WSD 110 and/or the gateway device can include an interface (not shown) to provide a user with information. Such an interface can comprise a liquid-crystal display (LCD), one or more light emitting diodes (LEDs), etc.

WSD 110 further includes a battery 290. Because the wireless network can provide lower-power consumption, a battery having a long shelf life—such as an alkaline-, silver-oxide-, or lithium-based battery—can provide for operability of the WSD 110 without the need to change batteries for several years. According to one embodiment, a WSD 110 uses up to 4 A-size 3.6 volt (V) batteries, each battery rated at approximately 3600 milliamp hours (mAh). Some embodiments of the WSD 110 have an operating power of under 2 milliwatts (mW); other embodiments of the WSD operate under 1 mW. Therefore, depending on the battery's shelf life and capacity, as well as the configuration of the WSD 110, the WSD 110 can operate for 10 years or more without the need to change the battery.

The WSD 110 can also include a GPS unit 280 to provide location information. Location information can be particularly useful where a sensor network 140 is spread over a large physical area. Moreover, the GPS unit 280 further can be used to sense motion of the WSD 110 by determining, by the GPS unit 280 and/or the processing unit 210 a change in location over time.

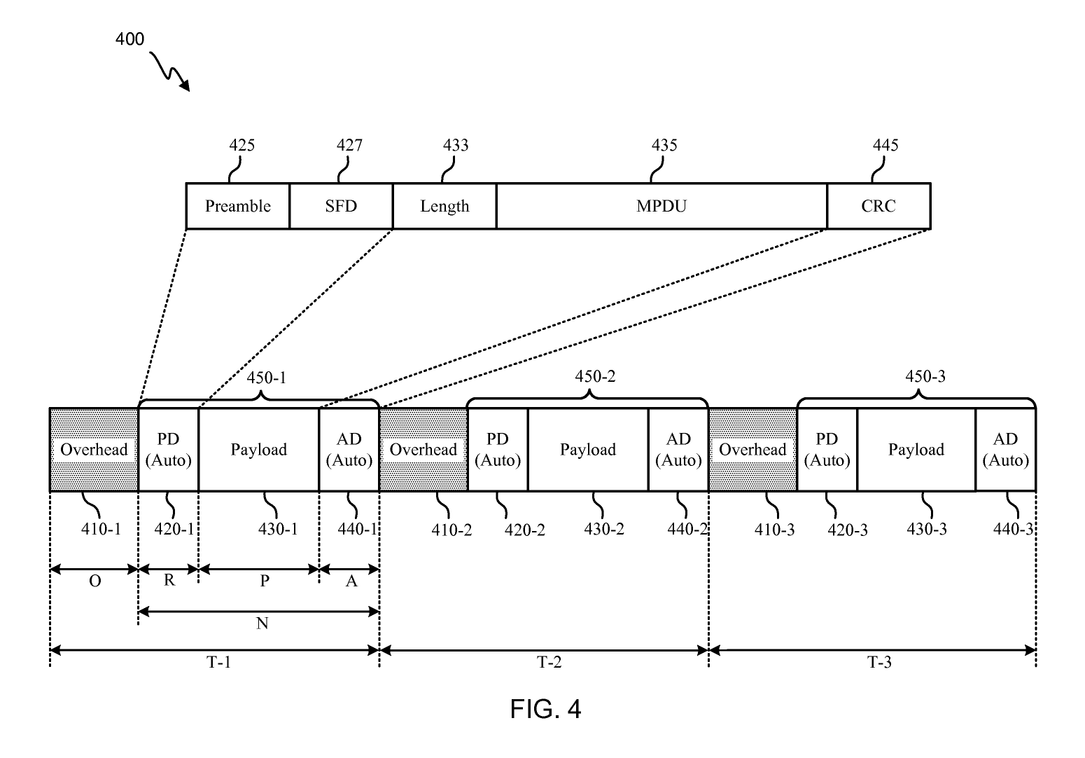

FIG. 4 is an illustration representing a typical packet-based communication 400 in a low-power wireless network. Typical packet-based processing units 210 can be characterized by the ability to send a payload 430, which does not exceed time P and a certain data rate S. For example, a payload 430 under the IEEE 802.15.4 standard is a Physical Service Data Unit (PSDU) limited by a 127-octet MAC protocol Data Unit (MPDU) 435, a length designation 433, and a data rate of 250 Kbit/s. A typical packet-based processing unit 210 also automatically frames the payload 430 by prepending the payload 430 with prepended data (PD) 420 and appending the payload 430 with appended data (AD) 440 to the payload 430, resulting in a data packet 450. Under the IEEE 802,15,4 standard, the packet 450 is a Physical Protocol Data Unit (PPDU) that includes the PSDU payload. The PD can contain standard control elements, preamble 425, start frame delimiter (SFD) 427, and/or other data elements. The AD also can contain standard control elements, such as a cyclic redundancy check (CRC) 445 and/or other data. Where the PD 420 takes time R to transmit, and the AD 440 takes time A to transit, the total duration N to transmit each data packet 450 can be calculated by:

R+P+A=N. (1)

This calculation can apply to standards in which control data elements use the same modulation as the payload 430. Each time a packet 450 is sent, the processing unit 210 has:

Overhead for preparing the payload 430,

Processing unit calibration overhead, and

Overhead for initiating the transaction itself.

The total overhead 410 amounts to O. Thus, total data packet 450 duration plus overhead calculated by:

N+O=T. (2)

Sending n data packets 450 therefore can take n*T time. For example, sending 3 data packets, as shown in FIG. 4, can take 3T time, where data packets 450 for the first, second, and third packets have times T-1, T-2, and T-2, respectively. Because each data packet 450 is associated with its own overhead 410, data packets 450 can have unfavorably high ratio of overhead 410 to payload 430, particularly where payloads 430 are relatively small. For example, a beacon sequence utilized by WSDs 110 of the logistical management systems 100 of FIGS. 1A-1B using packet-based processing units typically has small payloads with very large overhead 410. This can be particularly detrimental to the battery life of the WSDs 110 because the WSDs 110 transmit beacon sequences relatively often, and it takes extra time and power to transmit the overhead 410 for each beacon sequence.

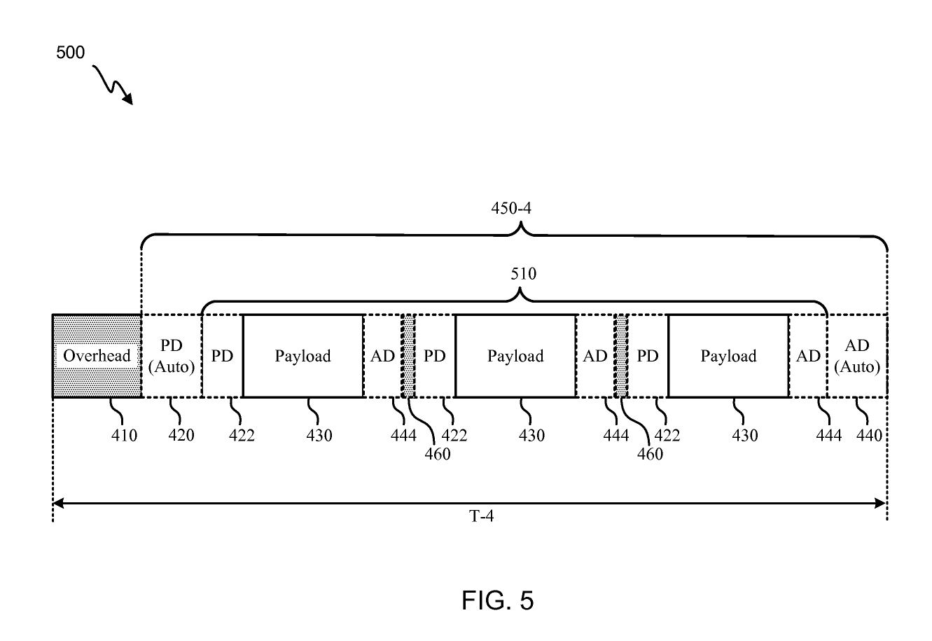

According to one embodiment, the ratio of overhead 410 to payload 430 can be reduced by aggregating multiple payloads 430 into a single data packet 450. Put in the terminology of IEEE 802.15.4 standards, embodiments herein aggregate multiple logical PPDUs within the payload (PSDU) of a single PPDU. The number of payloads 430 is only limited by the maximum payload size of the packet-based radio and/or governing protocol. FIG. 5 illustrates an example 500 of a data packet 450-4 resulting from such payload aggregation. Here, multiple payloads 430 are aggregated into an aggregated payload 510, where each payload 430 therein can be prepended and/or appended “manually” with respective PD 422 and/or AD 444. Some embodiments may not utilize prepended payload data, in which case PD 422 may be omitted. Here, the process is referred to as a “manual” process because many processing units utilized in certain wireless standards (e.g., IEEE 802.15.4) often are not configured to execute this functionality automatically. Furthermore, embodiments may utilize processing units 210 that are configured to automatically prepend PD 420 and append AD 440 to the aggregated payload 510. In such embodiments, the PD 420 and/or AD 440 can be overwritten (e.g. replacing AD 440 of the aggregated payload with AD 444 of the last payload 430), if possible, or simply disregarded by the receiving WSD 110 (or other receiving device).Embodiments that do not utilize processing units that automatically insert PD 420 and/or AD 440 may omit PD 420 and/or AD 440 entirely.

According to some embodiments, gaps 460 may be inserted between the AD 444 of one payload 430 and the PD of a subsequent payload 430. This may be dependent on hardware requirements of the particular WSDs 110 (and/or other transmitting/receiving devices) for synchronization purposes. In some embodiments, the length of time of these gaps 460 may be variable. Other embodiments may allow a user to provide input that would generate gaps 460 within an acceptable range. For example, the minimum limit of the range can be 0 seconds, and the maximum limit can meet or exceed any associated hardware requirements.

The aggregation of payloads 430 and insertion of gaps 460, as well as the “manual” and/or automatic appending and prepending of data, can be implemented in hardware and/or software. For instance, in certain wireless standards (e.g., IEEE 802.3) hardware may be configured to aggregate payloads in RAM, which can be pipelined by the processing unit automatically. Other hardware may include specialized circuitry and/or software, as discussed above in relation to FIG. 3.

The data packet 450-4 resulting from applying the data aggregation techniques described herein can result in reduced power consumption and network synchronization time for WSDs 110. Due to the high power consumption of radio frequency (RF) transmitters and receivers compared to microprocessors, reducing RF overhead or translating it to microprocessor overhead can significantly reduce power consumption. This is particularly the case in low-power radio frequency solutions where transmit operations constitute significant part of the power budget. For example, embodiments utilizing an IEEE 802.15.4 radio can save up to 25% sending smallest size (1 octet) payloads.

Also, among other benefits, these techniques can increase efficiency. For example, if k packets are aggregated into a single data packet 450, the efficiency savings can amount to (k-1)*O. This improves efficiency because the processor has more time to perform other tasks. Subsequently, it reduces task contention inside the processor.

Even so, in some situations (e.g., where only a few, large data payloads are available for aggregation) the data payload aggregation and insertion of gaps 460 described herein may not be as efficient as in traditional techniques, in certain embodiments. This may be dependent on the hardware components and/or software algorithms utilized. In such cases, embodiments can be configured to calculate efficiencies, using hardware and/or software, and determine whether to transmit the packets using traditional transmission techniques or the payload aggregation techniques described herein.

The aggregation techniques described herein can be used for ad-hoc low-power joining where the very absence of interframe gaps allows devices to have a more predictable joining pattern while maintaining lower-power operation. For example, beacons can be sent in sequence, and shorter scans can result in reliable beacon capture.

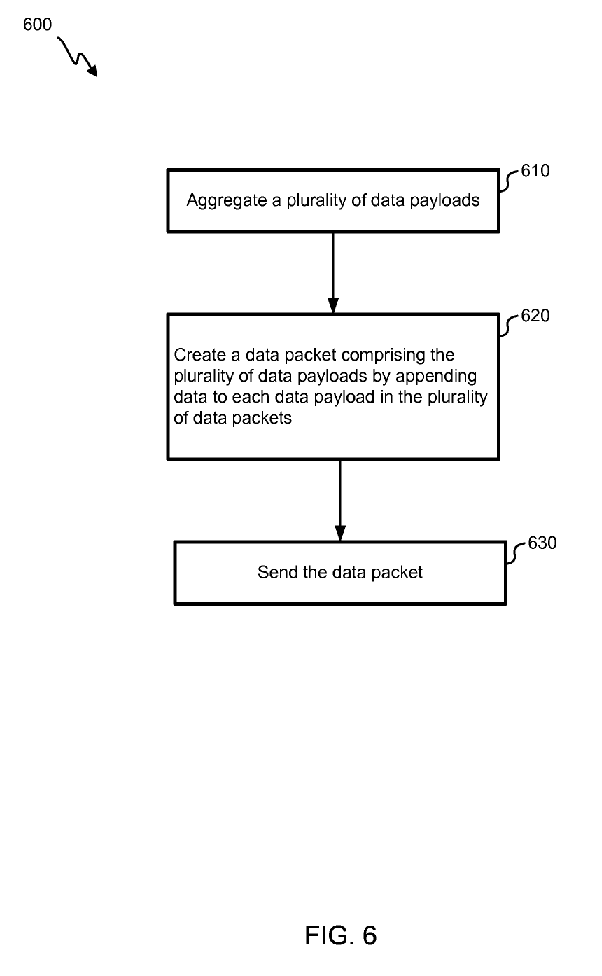

FIG. 6 is a flow diagram illustrating a method 600 for payload aggregation and transmission, according to one embodiment. The processes at each of the blocks in the method 600 can be performed, for example, by a WSD 110, a gateway 130, or similar networked device in a low-power wireless network. At block 610 a plurality of data payloads are aggregated. As discussed previously, means for performing such aggregation can be provided by software and/or hardware, such as the processing unit 210, memory 220, and/or software 225 illustrated in FIG. 2.

Payload aggregation may be performed in various ways, based on network synchronization, power savings, desired functionality, and other concerns. For example, embodiments may be configured to aggregate payloads until a certain amount of time has passed, a threshold number of payloads has been received, a specific time, the size of the aggregated payloads has reached a certain threshold, and/or similar conditions occur. Some embodiments may aggregate data payloads of a certain type (e.g., beaconing sequences) and/or size (e.g., smaller than a certain threshold size)

At block 620 a data packet comprising the plurality of data payloads is created. The data packet is created by appending data to each data payload in the plurality of data payloads. As discussed above, data may also be prepended to each payload. Although prepended and/or appended data provided in the examples herein include a 12-symbol delay, preamble, SFD, and CRC, embodiments are not so limited. Prepended and/or appended data can include any of a variety of data items desired to be transmitted on a per-payload basis, depending on desired functionality. Means for creating the data packet also can be provided by software and/or hardware, such as the processing unit 210, memory 220, and/or software 225 illustrated in FIG. 2.

Finally, at block 630, the data packet is sent. The data packet may be sent in any of a variety of methods, depending on the embodiment. Means for sending the data packet can be provided by software and/or hardware, such as the wireless interface 240, processing unit 210, memory 220, and/or software 225 illustrated in FIG. 2.

It should be appreciated that the specific steps illustrated in FIG. 5 provide an example of payload aggregation and data packet transmission according to the techniques described herein. Alternative embodiments may include alterations to the embodiments shown. For example, alternative embodiments may include differing techniques for aggregating data payloads and/or prepending data to data payloads. Other embodiments may include inserting gaps between data payloads as discussed herein above. Furthermore, additional features may be added or removed depending on the particular applications. One of ordinary skill in the art would recognize many variations, modifications, and alternatives.

Although embodiments herein frequently are disclosed in the context of sensor networks 140, they are not limited to sensor networks, nor are they limited to transportation or logistical applications. Methods and devices disclosed herein can apply to wireless networks communicating information other than sensor information, such as identification, time, security, and/or location information. Indeed, any number of wireless networks can utilize the features disclosed herein for lower power consumption, predictable and consistent power consumption, and other benefits. Similarly, the techniques described herein pertaining to WSDs 110 can be applied more broadly to network devices in general. These more general network devices, for example, may not gather or transmit sensor data.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-readable instructions, such as programming code, which may be used to cause a machine, such as a general-purpose or special-purpose processor or logic circuits programmed with the instructions to perform the methods. These machine-readable and/or computer-readable instructions may be stored on one or more non-transitory storage mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the disclosed systems, methods, and devices have been described in detail herein, it is to be understood that the inventive concepts may be otherwise variously embodied and employed, and that the appended claims are intended to be construed to include such variations, except as limited by the prior art.

What is claimed is:

1. A network device for communicating with an ad-hoc, low-power wireless network, the network device comprising:
a battery;
a wireless interface; and
a processing unit coupled with the battery and the wireless interface, wherein the processing unit configured to cause the network device to:
aggregate a first plurality of data payloads;
create a first data packet comprising the first plurality of data payloads by appending data to each data payload in the first plurality of data payloads; and
send the first data packet via the wireless interface.

2. The network device for communicating with the ad-hoc, low-power wireless network recited in claim 1, wherein the processing unit is further configured to cause the network device to create the first data packet by prepending data to each data packet in the first plurality of data packets.

3. The network device for communicating with the ad-hoc, low-power wireless network recited in claim 1, wherein the processing unit is configured to cause the network device to, for first and second data payloads in the first plurality of data payloads, insert a gap between the appended data of the first data payload and the prepended data of the second data payload.

4. The network device for communicating with the ad-hoc, low-power wireless network recited in claim 3, wherein a length of time of the gap is based on user input.

5. The network device for communicating with the ad-hoc, low-power wireless network recited in claim 1, wherein the processing unit is configured to cause the network device to include either or both of a preamble or a start frame delimiter (SFD) in the prepended data for each data payload in the first plurality of data payloads.

6. The network device for communicating with the ad-hoc, low-power wireless network recited in claim 1, wherein the processing unit is configured to cause the network device to include a cyclic redundancy check (CRC) in the appended data for each data payload in the first plurality of data payloads.

7. The network device for communicating with the ad-hoc, low-power wireless network recited in claim 1, wherein:
the processing unit is configured to cause the network device to receive, via the wireless interface, a second data packet comprising a second plurality of data payloads; and
each data payload of the second plurality of data payloads has corresponding prepended data and appended data.

8. The network device for communicating with the ad-hoc, low-power wireless network recited in claim 7, wherein the processing unit is configured to cause the network device to disregard either or both of:
prepended data corresponding to the entire second data packet, or
appended data corresponding to the entire second data packet.

9. The network device for communicating with the ad-hoc, low-power wireless network recited in claim 1, further comprising at least one sensor communicatively coupled with the processing unit.

10. A method for communicating data via an ad-hoc, low-power wireless network, the method comprising:
aggregating a plurality of data payloads;
creating, using a processing unit, a first data packet comprising the plurality of data payloads by appending data to each data payload in the plurality of data payloads; and
sending the first data packet via a wireless interface.

11. The method for communicating data via the ad-hoc, low-power wireless network recited in claim 10, wherein creating the first data packet further comprises prepending data to each data packet in the plurality of data packets.

12. The method for communicating data via the ad-hoc, low-power wireless network recited in claim 10, further comprising, for first and second data payloads in the plurality of data payloads, inserting a gap between the appended data of the first data payload and the prepended data of the second data payload.

13. The method for communicating data via the ad-hoc, low-power wireless network recited in claim 12, wherein a length of time of the gap is based on user input.

14. The method for communicating data via the ad-hoc, low-power wireless network recited in claim 10, further comprising including either or both of a preamble or a start frame delimiter (SFD) in the prepended data for each data payload in the plurality of data payloads.

15. The method for communicating data via the ad-hoc, low-power wireless network recited in claim 10, further comprising including a cyclic redundancy check (CRC) in the appended data for each data payload in the plurality of data payloads.

16. The method for communicating data via the ad-hoc, low-power wireless network recited in claim 10, wherein at least one data payload of the plurality of data payloads includes beaconing data from a wireless network device, the beaconing data including information for connecting with the ad-hoc, low-power wireless network.

17. A non-transitory computer-readable medium having instructions embedded thereon for communicating data via an ad-hoc, low-power wireless network, the instructions including computer-executable code for:
aggregating a plurality of data payloads;
creating a first data packet comprising the plurality of data payloads by appending data to each data payload in the plurality of data payloads; and
sending the first data packet via a wireless interface.

18. The non-transitory computer-readable medium recited in claim 17 wherein the computer-executable code for creating the first data packet comprises code for prepending data to each data payload in the plurality of data payloads.

19. The non-transitory computer-readable medium recited in claim 17, further comprising computer-executable code for, for first and second data payloads in the plurality of data payloads, inserting a gap between the appended data of the first data payload and the prepended data of the second data payload.

20. The non-transitory computer-readable medium recited in claim 19, further comprising computer-executable code for determining a length of time of the gap is based on user input.

21. The non-transitory computer-readable medium recited in claim 17, further comprising computer-executable code for including either or both of a preamble or a start frame delimiter (SFD) in the prepended data for each data payload in the plurality of data payloads.

22. The non-transitory computer-readable medium recited in claim 17, further comprising computer-executable code for including a cyclic redundancy check (CRC) in the appended data for each data payload in the plurality of data payloads.

23. The non-transitory computer-readable medium recited in claim 17, wherein at least one data payload of the plurality of data payloads includes beaconing data from a wireless network device, the beaconing data including information for connecting with the ad-hoc, low-power wireless network.
